(19) United States
(12) Patent Application Publication
(10) Pub. No.: US 2009/0132266 A1
(43) Pub. Date: May 21, 2009

(54) WEIGHTED CONDITION PRIMITIVE FOR DESCRIPTIVE BUSINESS POLICY

(76) Inventors: I-Lung Kao, Round Rock, TX (US); Dah-Haur Lin, Austin, TX (US)

Correspondence Address: IBM CORP (YA);C/O YEE & ASSOCIATES PC, P.O. BOX 802333, DALLAS, TX, 75380, US

(21) Appl. No.: 11/942,300

(22) Filed: Nov. 19, 2007

(51) Int. Cl. G06Q 30/00; G06Q 10/00

(52) U.S. Cl. 705/1

(57) ABSTRACT

A method, system, and computer program product for using weighted condition primitives to facilitate the description of a business policy for providing a web service to a user. When a set of facts associated with a user requesting a web service is obtained, an evaluation of each weighted condition primitive in a business policy is performed using the set of facts. A weight value assigned to a result of the evaluation of each weighted condition primitive is identified, and a total weight value of the identified weight values is calculated. The total weight value is then compared against a pre-defined business weight threshold condition. If the total weight value satisfies the pre-defined business weight threshold condition, the web service is provided to the user. If the total weight value does not satisfy the pre-defined business weight threshold condition, the request by the user for the web service is denied.

### BACKGROUND OF THE INVENTION

1. Field of the Invention

The present invention relates generally to an improved data processing system, and in particular, to a computer implemented method, data processing system, and computer program product for using weighted condition primitives to facilitate the description of a business policy.

2. Description of the Related Art

A Service-Oriented Architecture (SOA) is a collection of services that communicate with one another over a network in order to carry out business processes. Communication in an SOA can involve the simple passing of data or it can involve two or more services that coordinate some activity. Such services are loosely coupled (meaning that one application does not need to know the implementation details of another application in order to communicate with the other application), have well-defined platform independent interfaces, and are reusable. In general, a service-oriented approach enables one or more businesses to link together fragmented data and business processes in order to create a more complete view of operations. For example, a retail business deciding whether to issue a credit card to a customer can use SOA technology to tap different available sources to pull together information on the customer's credit worthiness and buying habits. A bank can use the same SOA to handle account transfers whether they originate from a teller, an ATM or a Web application, thus avoiding the need for multiple applications. As yet another example, a manufacturer can effectively use SOA to measure a production process, and then make appropriate adjustments to the process that feed back instantly to its chain of suppliers.

Within the SOA environment, a text-based extensible markup language (XML)-based descriptive policy representation has become the dominant language to describe today's business policies. A business policy comprises one or more business rules that contain conditions and actions that apply to an organization in achieving its business goals. A rule typically resembles an if/then statement, wherein the “if” part of a rule is referred to as a condition, and the “then” part of a rule is referred to as an action. When a business policy executes, information about the particular situation (facts) are loaded into the memory of the executing policy.

In an if/then statement, one of the key XML-based primitives used to decide optional situations is the “condition” primitive. The evaluation result of a condition primitive is a Boolean “TRUE” or “FALSE” decision. In order to take into consideration for various real world situations, the condition primitives may need to be used repetitively in order to fully and exactly describe the required business policy. Consider, for example, a scenario in which a credit card company has an on-line purchase system that allows its members to shop various discount merchandisers based on a member's card membership level. The spending limit for each membership level is different. A gold membership may have a $20,000 credit limit, a silver membership may have a $10,000 credit limit, and a regular membership may have a $5,000 credit limit. Also, the credit card company provides certain incentive policies (e.g., upgrade from regular membership to silver membership with no annual fee for one year) to encourage existing card members to upgrade to a higher level membership. In view of the rules above, the following example situations may occur:

Scenario A1: Customer A (who has regular membership) wants to purchase $8,000 worth of merchandise for her wedding on-line. But her current credit card membership only allows her to purchase up to $5,000 in merchandise. As a result, her purchases over her credit limit will be declined, which may affect her wedding preparation plans. Such a result will not be what either the credit card company or Customer A wants to occur.

Scenario A2: Because Customer A has a great credit history and the credit card company has the membership upgrade incentive policy, if Customer A applies for a membership upgrade application from regular to silver membership (which will give her a $10,000 credit line), the credit card company will approve the upgrade application immediately. In this case, the credit card company gets a new silver membership member, and Customer A is happy for the service and is able to make all the purchases she needs.

Scenario B1: Customer B has a similar situation as Customer A in Scenario A1, except Customer B is still a student so she has only accumulated a limited credit history. In this situation, Customer B's purchase exceeding the $5000 credit limit will be declined, and Customer B may need to go to different places to complete her wedding purchases. The inconvenience may impact Customer B's wedding arrangements, and the credit card company may lose Customer B as a customer because of customer's B perception of having received bad service.

Scenario B2: In this scenario, Customer B is planning to make all the purchases from the same on-line shop to save time, but uses the credit line of her parent's credit card to pay for the goods. If the credit card company has taken into account this kind of customer scenario and the on-line system is designed to implement such a policy, both the credit card company and Customer B will all be happy with the end result.

However, in the example above, if the credit card company deploys an SOA to implement their online purchase system and only uses the traditional if/then condition primitive in their business policy statement, the resulting business authorization policy may be very complicated. The resulting policy will contain repetitive usage of the condition primitive to determine the other credit availability of Customer B's parents' credit card in order to approve Customer B's purchases. In addition, the resulting policy would be difficult to maintain due to the hidden Boolean logic. Furthermore, the resulting policy would be hard to manage when business policy needs to change, since a business policy author must interpret all of the business logic to determine if the change will adversely affect the existing decision elements in the policy or cause other sub policy permutations.

### SUMMARY OF THE INVENTION

The illustrative embodiments provide a computer implemented method, data processing system, and computer program product for using weighted condition primitives to facilitate the description of a business policy for providing a web service to a user. When a set of facts associated with a user requesting a web service is obtained, an evaluation of each weighted condition primitive in a business policy is performed using the set of facts. A weight value assigned to a result of the evaluation of each weighted condition primitive is identified, and a total weight value of the identified weight values is calculated. The total weight value is then compared against a pre-defined business weight threshold condition. If the total weight value satisfies the pre-defined business weight threshold condition, the web service is provided to the user. If the total weight value does not satisfy the pre-defined business weight threshold condition, the request by the user for the web service is denied.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the illustrative embodiments may be implemented;

FIG. 2 is a block diagram of a data processing system in which the illustrative embodiments may be implemented;

FIG. 3 is a block diagram of an exemplary data processing system in which aspects of the illustrative embodiments may be implemented;

FIG. 4 illustrates an exemplary XML-based policy comprising conventional condition primitives;

FIG. 5 illustrates an exemplary XML-based policy comprising weighted condition primitives in accordance with the illustrative embodiments; and

FIG. 6 is a flowchart of a process for using weighted condition primitives to facilitate the description of a business policy in accordance with the illustrative embodiments.

### DETAILED DESCRIPTION OF THE PREFERRED EMBODIMENT

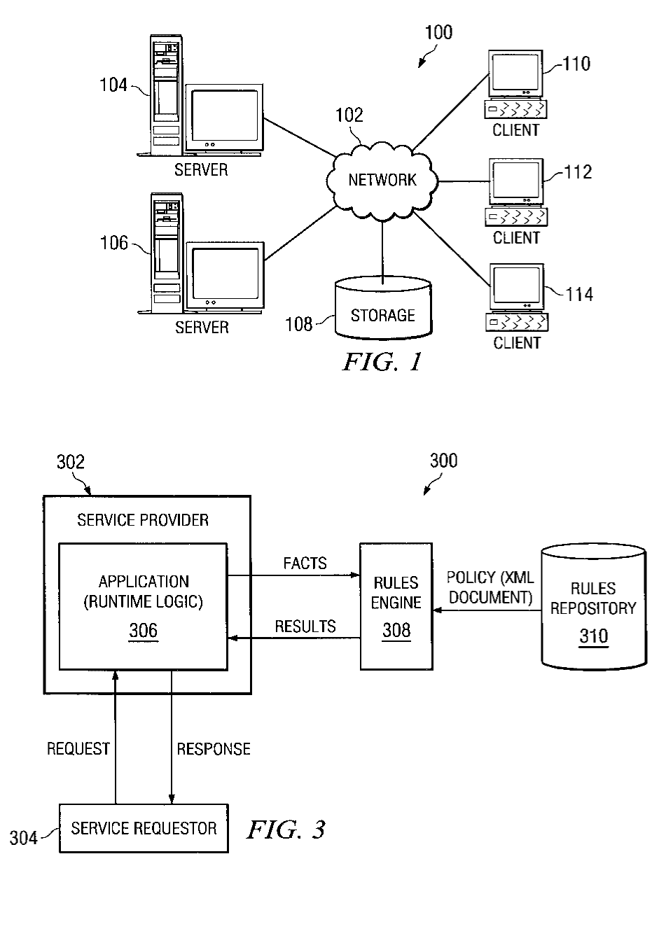

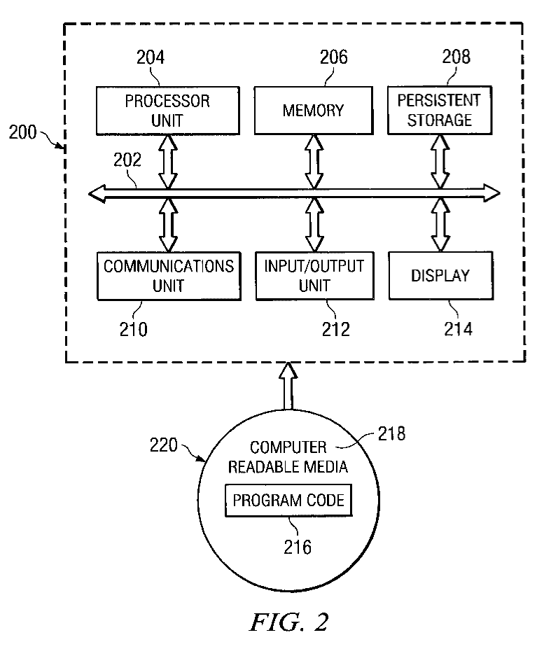

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data and services, usually implemented as applications with well defined interfaces to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as, program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200. The tangible form of computer readable media x18 is also referred to as computer recordable storage media.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The illustrative embodiments provide a “weighted condition” primitive to facilitate the description of a policy in a simpler and better way for many complicated business situations. Specifically, the weighted condition primitive allows the description of a business policy to contain simpler decision making logic, which also leads to easier policy statement maintenance. In contrast with conventional policy descriptions which allow only Boolean TRUE or FALSE results from use of the condition primitive, the result of a weighted condition primitive evaluation is a weight value. A weight value is assigned to each weighted condition primitive in the policy at the business policy specification time. The weight value of each weighted condition primitive is assigned based on the importance of the condition as determined from the overall business consideration. During a weighted condition primitive evaluation, if a result of the weighted condition is evaluated as positive or “TRUE” in the enclosed expression, the weight value assigned to the weighted condition primitive is returned. If the weighted condition is evaluated as negative or “FALSE” in the enclosed expression, no assigned weight value or weight value of “0” is returned.

The proposed weighted condition primitive is complementary to the conventional condition primitive, but the weighted condition primitive significantly increases the powerfulness of the policy language. A combination of condition and weighted condition primitives may render much flexibility to policy designers to describe and implement various kinds of business policies that are also easier to maintain.

Thus, the weighted condition primitives solution described in the illustrative embodiments may be used to define a flexible business policy that can handle many different situations without complicated programming logic embedded in the policy. Additionally, the weighted condition primitives solution also provides a generic way to compliment existing business policy so that temporary business requirements can be handled without changing the business policy evaluation logic, and/or the business policy itself.

FIG. 3 is a block diagram of an exemplary data processing system in which aspects of the illustrative embodiments may be implemented. Data processing system 300 in this illustrative example comprises a service oriented architecture (SOA). SOA is a software architecture that is a platform independent collection of web services which are available to software applications and network end users. A web service is an interface that describes a collection of operations that are network accessible through standardized extensible markup language (XML) messaging. A web service fulfills a specific task or a set of tasks. A web service is described using a standard format XML notation called its service description, which provides all of the details necessary to interact with the service, including message formats, transport protocols, and location. Thus, in one illustrative embodiment, service provider 302 can implement a particular web service. A customer operating a remote computing device, such as service requester 304, generates a request for the web service. After the web service is located and contacted, the web service performs the necessary actions to provide the service to service requester 304. The web service then presents the results to the service requester 304, usually implemented in a remote computing device.

Service requester 304 may be implemented as a client in the service oriented architecture, such as client 110, 112, or 114 in FIG. 1. In terms of the previously described scenarios in which a credit card company validates on-line purchases of member customers, an example of service requester 304 may be customer A or B. Service requestor 304 invokes a service by sending a request for the service to service provider 302. In this particular example, the request is an authorization request for service provider 302 to approve the on-line purchase of wedding items with the customer's credit card.

Service provider 302 may be implemented as a server in the service oriented architecture, such as server 104 or 106 in FIG. 1. Using the previously described example scenarios, an example of service provider 302 may be the credit card company providing the service of approving or denying the on-line purchases of customer A and B. when the request from service requester 304 is received at service provider 302, application 306 processes the request. Application 306 is a software component comprising runtime logic for a service, such as authorizing on-line purchases of a requesting member customer.

The authorization request received at service provider 302 from service requestor 304 needs to be based on a set of facts. These facts may be represented in XML or, in another example, as Java objects. The facts provide specific information used to process the request, such as, for example, information about the requesting customer, the customer's membership status, the customer's credit history, etc. Application 306 collects these facts and presents them to rules engine 308.

Rules engine 308 comprises software for managing and automating business rules. Business rules describe the operations, definitions, and constraints that apply to an organization in achieving its goals. Rules may be grouped to form a policy, and rules engine 308 implements the policy against particular facts received. For example, if the facts received from application 306 specify that a customer's credit limit is $5000 and the customer's on-line purchases total $8000, rules in the policy will specify that customer's purchases exceeding the credit limit will be denied. To execute the business policy, rules engine 308 obtains a business policy from rules repository 310 and applies the facts provided by application 306 to the policy. Rules engine 308 then provides the results of the business policy evaluation to application 306.

Application 306 receives the policy evaluation results from rules engine 308. Based on the results, application 306 may or may not provide the requested service to service requester 304. For instance, application 306 may approve the customer's purchase request if the policy evaluation results indicate that the required conditions for purchase approval have been met, or deny the customer's purchase request if the policy evaluation results indicate that the required conditions for purchase approval have not been met.

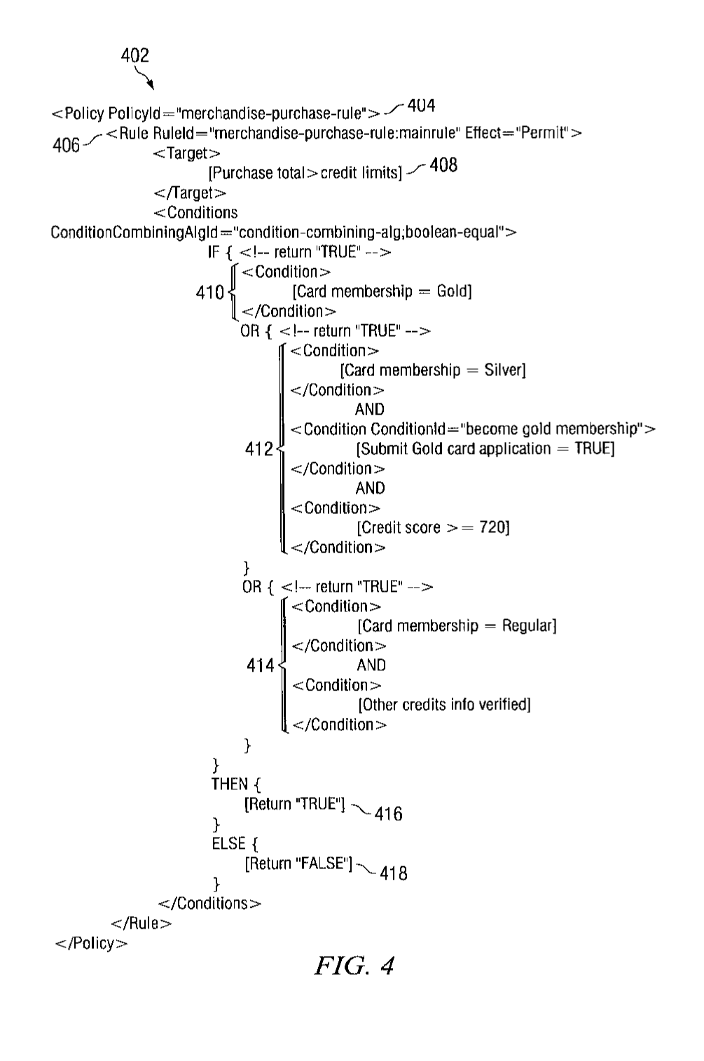

FIG. 4 illustrates an exemplary XML-based policy comprising conventional condition primitives. XML-based policy 402 is a conventional business policy comprising multiple condition primitives which represent rules in the policy. In this illustrative example, XML-based policy 402 is applied to the previously described fact scenarios in which a credit card company validates on-line purchases of member customers A and B.

XML-based policy 402 first specifies the name of the policy (e.g., merchandise-purchase-rule 404). The policy contains a rule 406 which is applied to or targets customer purchase requests where the purchase total is greater than the customer's current credit limit 408. Customer purchase requests which are greater than the customer's current credit limit are evaluated by the policy using condition primitives. These condition primitives are contained in an if/then statement in the policy.

In the “if” portion of the if/then statement, several condition primitives are used to determine if the requesting customer meets specified requirements for purchasing items which exceed the current credit limit of the customer. If any of these condition primitives are evaluated as “TRUE”, then the policy returns a TRUE value to the requesting application. An evaluation of TRUE means that the credit card company will approve the customer request, since the customer meets specified requirements for purchasing items which exceed the current credit limit of the customer according to the policy.

A first condition primitive 410 in the “if” portion of the if/then statement evaluates whether the requesting customer has a gold membership. A second set of condition primitives 412 evaluates whether the requesting customer has a silver membership, the customer has submitted a request for gold membership, and the credit score of the customer is greater than or equal to 720. A third set of condition primitives 414 evaluates whether the requesting customer has a regular membership and also has other verified credit information, such as credit lines from other available credit card accounts. If any of condition primitives 410-414 are met, XML-based policy 402 returns a value of TRUE 416, and the credit card company will subsequently approve the customer purchase request, even if the customer's purchases are greater than the customer's current credit limit. However, if none of condition primitives 410-414 are met, XML-based policy 402 returns a value of FALSE 418, and the credit card company will subsequently deny the customer purchase request.

Conventional XML-based policy 402 illustrates particular examples of condition primitives. However, some situations, such as the B2 scenario described previously, may cause a policy employing conventional condition primitives to become complicated and difficult to manage. For example, the resulting policy may become complicated since the policy will contain repetitive usage of the condition primitive to determine the other credit availability of the customer's parents' credit card in order to approve the customer's purchases, as well as to determine if the customer's purchases fall within the credit limit of the parent's credit card. In addition, it is difficult to adopt policy changes or evaluation logic changes to accommodate the change of the business situation when using policies employing conventional condition primitives, since a user must re-examine or re-interpret all of the business logic to determine if the change will adversely affect the existing decision elements in the policy or cause other sub policy permutations. Thus, a policy employing conventional condition primitives will require more human “interpretation” of the policy decision logic when changes to the policy are required.

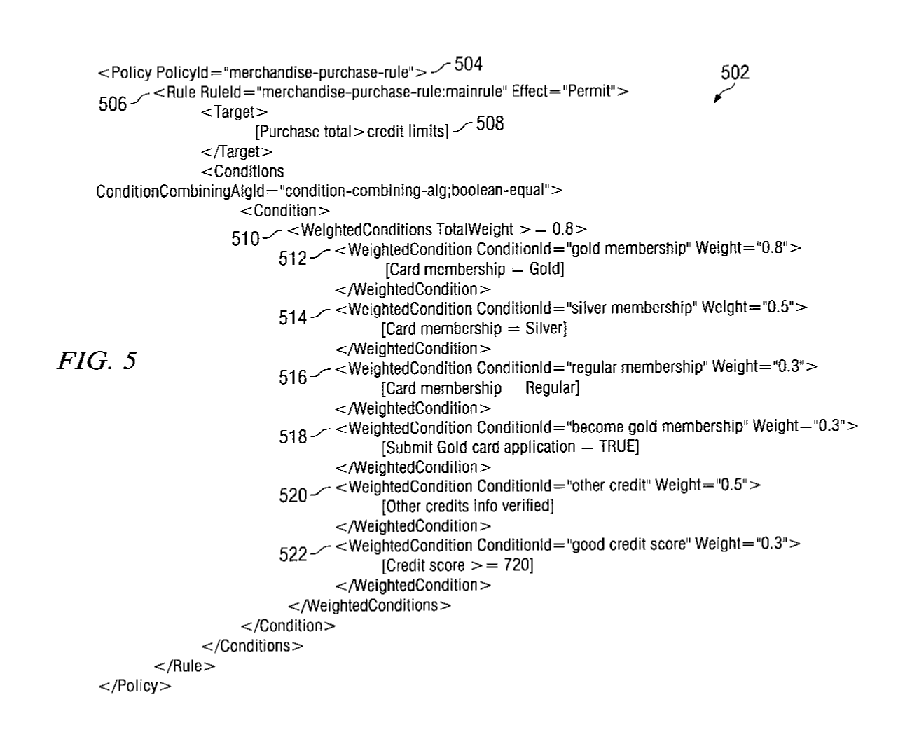

FIG. 5 illustrates an exemplary XML-based policy comprising weighted condition primitives in accordance with the illustrative embodiments. XML-based policy 502 is a business policy comprising weighted condition primitives representing rules in the policy. The weighted condition primitives are used in policy evaluation to produce a result that is more in-line with both business and customer expectations. In this illustrative example, XML-based policy 502 is applied to the previously described fact scenarios in which a credit card company validates on-line purchases of member customers A and B. XML policy 502 may be obtained from rules repository 310 and executed by rules engine 308 in FIG. 3.

XML-based policy 502 first specifies the name of the policy (e.g., merchandise-purchase-rule 504). Like XML-based policy 402 in FIG. 4, the policy contains a rule 506 which is applied to or targets customer purchase requests where the purchase total is greater than the customer's current credit limit 508. However, unlike XML-based policy 402 in FIG. 4, XML-based policy 502 evaluates customer purchase requests which are greater than the customer's current credit limit using weighted condition primitives.

XML-based policy 502 is controlled by pre-defined business weight threshold condition 510 in the collective weighted condition primitive. Business weight threshold condition 510 indicates the minimum weighted value which must be met for service provider 302 to perform the service requested by service requestor 304 in FIG. 3. XML-based policy 502 also contains weighted condition primitives which are independent of one another. Each weighted condition comprises a weight value. The weight value indicates the overall importance of the condition to the overall business policy evaluation. XML-based policy 502 evaluates each of the weighed conditions in the policy against the facts obtained in the customer request. An important advantage of having each weighted condition independent of the other weighted conditions is that the rules engine may evaluate the weighted conditions in any order. After all of the weighted conditions have been evaluated, an accumulated total weight value is calculated as a sum of the weights determined from each evaluation. If the accumulated weight value of the weighted conditions satisfies business weight threshold condition 510, the credit card company will subsequently approve the customer purchase request. If the accumulated weight value of the weighted conditions does not satisfy business weight threshold condition 510, the credit card company will subsequently deny the customer purchase request.

With XML-based policy 502, if there is a need to implement a business policy change (e.g., more situations to be considered in the credit membership upgrade approval processes), a new weighted condition (and its associated weight value) may be added into the existing business policy without much effort. A new weighted condition may be added without any impact to other existing weighted conditions. Similarly, an overall change to the business policy evaluation may be easily reflected in a single change to the business weight threshold condition.

In this illustrative embodiment, one weighted condition to be evaluated against the facts in the customer request is weighted condition 512. Weighted condition 512 assigns a weight value of 0.8 if the customer currently has a gold membership. Thus, a gold membership is deemed to have the highest importance in the business policy evaluation of granting a purchase request. Similarly, weighted condition 514 assigns a weight value of 0.5 if the customer currently has a silver membership, and weight condition 516 assigns a weight value of 0.3 if the customer currently has a regular membership. In addition, weighted condition 518 assigns a weight value of 0.3 if the customer submits a request to upgrade to a gold membership, weighted condition 520 assigns a weight value of 0.5 of the customer has other verified credit sources, and weighted condition 522 assigns a weight value of 0.3 if the customer has a good credit score (e.g., a credit score greater than or equal to 720).

Once all of the weighted conditions in XML-based policy 502 have been evaluated, the rules engine may calculate a total of all of the weight values (accumulated) assigned in each weighted condition evaluation. If the total of the weighted condition values satisfies business weight threshold condition 510, then the result generated from the business policy is a positive result (e.g., “TRUE” or “YES”), and the credit card company will approve the customer purchase request. However, if the total of the weighted condition values does not satisfy business weight threshold condition 510, the result generated from the business policy is a negative result (e.g., “FALSE” or “NO”), and the credit card company will deny the customer purchase request.

It should be noted that while exemplary aspects of the illustrative embodiments are described in terms of business policies for use in a service oriented architecture space, the weighted condition primitives described in the illustrative embodiments are also applicable in any decision making logic in which language primitives, such as Boolean or true/false values, are employed as an evaluation result.

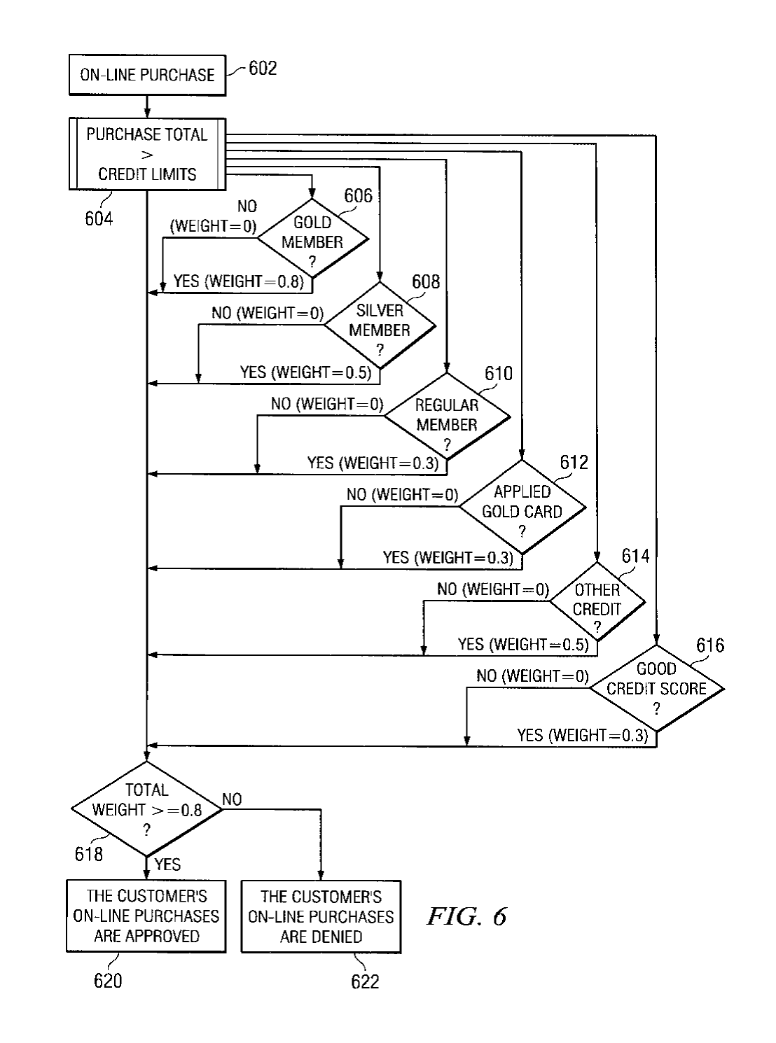

FIG. 6 is a flowchart of a process for using weighted condition primitives to facilitate the description of a business policy in accordance with the illustrative embodiments. The process described in FIG. 6 may be implemented by rules engine 308 in FIG. 3. The process using weighed condition primitives is also described in terms of the previously described fact scenarios in which a credit card company validates on-line purchases of member customers A and B.

The process begins when the rule engine receives facts about a customer request for an on-line purchase (step 602). The rules engine obtains a business policy (e.g., from rule repository 310 in FIG. 3) based on the information received. In this illustrative example, the rules engine obtains a business policy targeting the scenario in which a customer's purchase total is greater than the customer's credit limit (step 604). The business policy comprises various weighted conditions which are evaluated and used to produce a result that is controlled by a business weight threshold condition in the policy. Each weighted condition in the business policy is evaluated by the rules engine. Although the evaluation of the weighted conditions are described in this process in a particular order, since each weighted condition is independent of the other weighted conditions, the rules engine may process the weighted conditions in any order.

Once the rules engine obtains the desired business policy, the rules engine evaluates various weighted conditions. In one weighted condition, a determination is made as to whether the customer is a gold member (step 606). If the customer is a gold member, the weighted condition assigns a weight value of 0.8. If the customer is not a gold member, the weighted condition does not assign a weight value or assigns a weighted value of 0.

In a second weighted condition, a determination is made as to whether the customer is a silver member (step 608). If the customer is a silver member, the weighted condition assigns a weight value of 0.5. If the customer is not a silver member, the weighted condition does not assign a weight value or assigns a weighted value of 0.

In a third weighted condition, a determination is made as to whether the customer is a regular member (step 610). If the customer is a regular member, the weighted condition assigns a weight value of 0.3. If the customer is not a regular member, the weighted condition does not assign a weight value or assigns a weighted value of 0.

In a fourth weighted condition, a determination is made as to whether the customer has applied for a gold card upgrade (step 612). If the customer has applied for a gold card upgrade, the weighted condition assigns a weight value of 0.3. If the customer has not applied for a gold card upgrade, the weighted condition does not assign a weight value or assigns a weighted value of 0.

In a fifth weighted condition, a determination is made as to whether the customer has other credit sources available (step 614). If the customer has other credit sources available, the weighted condition assigns a weight value of 0.5. If the customer does not have other credit sources available, the weighted condition does not assign a weight value or assigns a weighted value of 0.

In a sixth weighted condition, a determination is made as to whether the customer has a good credit score (step 616). If the customer has a good credit score, the weighted condition assigns a weight value of 0.3. If the customer does not have a good credit score, the weighted condition does not assign a weight value or assigns a weighted value of 0.

Once all of the weighted conditions have been evaluated, the rules engine calculates an accumulated total of the weighted condition values and determines whether the total satisfies the business weight threshold condition specified in the business policy (step 618). If the total satisfies the business weight threshold condition, the result generated from the rules engine is a positive result (e.g., “YES”), and the service provider will approve the customer purchase request (step 620). If the total does not satisfy the business weight threshold condition, the result generated from the rules engine is a negative result (e.g., “NO”), and the service provider will deny the customer purchase request (step 622).

Thus, in the example process above, if a customer is a gold card member, the customer's purchases will be approved since the weight value evaluated for a gold member is 0.8, which satisfies the required business weight threshold condition. If a customer is a silver member, the customers purchases may not be approved since the weight value for a silver member is only 0.5. However, if the customer has applied for a gold card (weight=0.3), has other credit sources (weight=0.5), and/or has a good credit score (weight=0.3), the accumulated total for the silver member may equal or exceed the required business weight threshold condition. The same is true for a regular member (weight=0.3) who has other credit sources to consider (weight=0.5).

While the weighted condition primitives solution has been described in terms of a business policy solution for credit card company authorization, the weighted condition primitives solution is applicable in any situation where a flexible business policy is needed to handle different situations without complicated programming logic embedded in the policy. Other examples of business policies and situations where the weighted condition primitives solution may be implemented include, but are not limited to, the following: In health care, a child's medical record is protected by hospital's policy, and only the child's primary doctor can obtain access to the records. In the case of an emergency, other doctors (e.g., in other hospitals) handling the emergency may need to reference the child's medical history before they can decide the proper treatment. If a hospitals medical record access policy applied the weighted condition primitives solution, a few weighted conditions (e.g., parent's digital consent) may be defined in the business policy to handle such temporary situations so that the attending doctors can treat the patient in time without waiting for the patent's primary doctor's approval to access the needed medical records. In another example, for industry compliance audit (e.g., common criteria), an auditor has a need to obtain access to a lot of development documents, defect records, etc. usually, the access policy to those development files are defined under company's specific regulation and only developers can get to them. During the auditing, the auditor needs to ask several developers, help to get to these files. If some WeightedConditions (e.g., a limited time period accessed by certain name—auditor's name) are defined in the access policy for those files, the auditor can obtain access to these files and perform his work without interrupting the developer's routine work. In criminal investigation, an investigator may need to obtain access to the transaction records of a particular person in the bank. Of course, access to the bank's record is protected by their business policy, and only the permitted bank employees can obtain access to them. If a few WeightedConditions (e.g., warrant signed by the judge) can be added to the bank's record access policy, the investigator can perform his investigation as long as the judge's warrant is verified.

Thus, with the illustrative embodiments, weighted condition primitives are used to facilitate the description of a business policy. The business policy provides a clear expression of the weighted conditions and their associated assigned weights, which indicates the importance of the weighted conditions to the overall business policy evaluation. The use of weighted conditions enables the description of a business policy to contain more straightforward decision making logic, which also leads to easier policy maintenance. Thus, if a business policy change is needed, new weighted conditions and associated weight values may be added into the existing business policy without minimal effort in comparison to using conventional condition primitives. Similarly, a change to the overall business policy evaluation may be easily reflected in a change to the business weight threshold condition specified in the policy.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device. The program code may be stored in a computer readable storage medium in a client data processing system or a server data processing system.

The invention can also take the form of a computer program product which has been downloaded over a network from one device to another for use in the other device. For instance, the program code stored in a computer readable storage medium in a server data processing system may be downloaded over a network from the server to a remote data processing system, such as a client or another server. Likewise, the program code stored in a computer readable storage medium in a client data processing system may be downloaded over a network from the client to a remote data processing system, such as a server or another client.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for using weighted condition primitives in decision logic of a business policy evaluation for providing a web service to a user, the computer implemented method comprising:
responsive to receiving a request for a web service from a user, obtaining a set of facts associated with the user;
performing an evaluation of each weighted condition primitive in a business policy using the set of facts;
identifying a weight value assigned to a result of the evaluation of each weighted condition primitive;
calculating a total weight value of the identified weight values;
comparing the total weight value against a pre-defined business weight threshold condition;
responsive to a determination that the total weight value satisfies the pre-defined business weight threshold condition, providing the web service to the user; and
responsive to a determination that the total weight value does not satisfy the pre-defined business weight threshold condition, denying the request by the user for the web service.

2. The computer implemented method of claim 1, wherein the result of the comparison is a TRUE value if the total weight value satisfies the pre-defined business weight threshold condition, and wherein the result of the comparison is a FALSE value if the total weight value does not satisfy the pre-defined business weight threshold condition.

3. The computer implemented method of claim 1, wherein the result of the comparison is a Boolean value.

4. The computer implemented method of claim 1, wherein the weight value assigned to the result of the evaluation of each weighted condition primitive is based on an importance of the weighted condition primitive to the business policy evaluation.

5. The computer implemented method of claim 1, wherein each weighted condition primitive in the business policy is independent of other weighted condition primitives in the business policy.

6. The computer implemented method of claim 1, wherein the weighted condition primitives in the business policy are evaluated in any order.

7. The computer implemented method of claim 1, wherein a new weighted condition primitive is added to or an existing weighted condition primitive is removed from the business policy to reflect a change in a business situation.

8. The computer implemented method of claim 1, wherein adding a new weighted condition primitive includes associating a weight value to the new weighted condition primitive.

9. The computer implemented method of claim 1, wherein the business weight threshold condition is changed to reflect a change in the business policy evaluation.

10. The computer implemented method of claim 1, wherein the business weight threshold condition is specified in the business policy.

11. The computer implemented method of claim 1, wherein the business policy is described in extensible markup language.

12. A data processing system for using weighted condition primitives in decision logic of a business policy evaluation for providing a web service to a user, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to obtain a set of facts associated with a user in response to receiving a request for a web service from the user; perform an evaluation of each weighted condition primitive in a business policy using the set of facts; identify a weight value assigned to a result of the evaluation of each weighted condition primitive; calculate a total weight value of the identified weight values; compare the total weight value against a pre-defined business weight threshold condition; provide the web service to the user in response to a determination that the total weight value satisfies the pre-defined business weight threshold condition; and deny the request by the user for the web service in response to a determination that the total weight value does not satisfy the pre-defined business weight threshold condition.

13. A computer program product for using weighted condition primitives in decision logic of a business policy evaluation for providing a web service to a user, the computer program product comprising:
a computer usable medium having computer usable program code tangibly embodied thereon, the computer usable program code comprising:
computer usable program code for obtaining a set of facts associated with a user in response to receiving a request for a web service from the user;
computer usable program code for performing an evaluation of each weighted condition primitive in a business policy using the set of facts;
computer usable program code for identifying a weight value assigned to a result of the evaluation of each weighted condition primitive;
computer usable program code for calculating a total weight value of the identified weight values;
computer usable program code for comparing the total weight value against a pre-defined business weight threshold condition;
computer usable program code for providing the web service to the user in response to a determination that the total weight value satisfies the pre-defined business weight threshold condition; and
computer usable program code for denying the request by the user for the web service in response to a determination that the total weight value does not satisfy the pre-defined business weight threshold condition.

14. The computer program product of claim 13, wherein the weight value assigned to the result of the evaluation of each weighted condition primitive is based on an importance of the weighted condition primitive to the business policy evaluation.

15. The computer program product of claim 13, wherein each weighted condition primitive in the business policy is independent of other weighted condition primitives in the business policy.

16. The computer program product of claim 13, wherein the weighted condition primitives in the business policy are evaluated in any order.

17. The computer program product of claim 13, further comprising:
computer usable program code for adding a new weighted condition primitive to or removing an existing weighted condition primitive from the business policy to reflect a change in a business situation, wherein the computer usable program code for adding a new weighted condition primitive includes associating a weight value to the new weighted condition primitive.

18. The computer program product of claim 13, wherein the business weight threshold condition is changed to reflect a change in the business policy evaluation.

19. The computer program product of claim 13, wherein the computer usable program code is stored in a computer readable storage medium in a data processing system, and wherein the computer usable program code was downloaded over a network from a remote data processing system.

20. The computer program product of claim 13, wherein the computer usable program code is stored in a computer readable storage medium in a server data processing system, and wherein the computer usable program code are downloaded over a network to a remote data processing system for use in a computer readable storage medium with the remote data processing system.
